(19) United States
(12) Patent Application Publication
(10) Pub. No.: US 2020/0228719 A1
(43) Pub. Date: Jul. 16, 2020

(54) FOCUS CONTROL APPARATUS, IMAGING APPARATUS, FOCUS CONTROL METHOD, AND STORAGE MEDIUM

(71) Applicant: CANON KABUSHIKI KAISHA, Tokyo (JP)

(72) Inventor: Satoshi Kimoto, Saitama-shi (JP)

(21) Appl. No.: 16/733,313

(22) Filed: Jan. 3, 2020

(30) Foreign Application Priority Data
Jan. 11, 2019 (JP) 2019-003749

(51) Int. Cl. H04N 5/232

(52) U.S. Cl. CPC H04N 5/23296; H04N 5/23212

(57) ABSTRACT

A focus control apparatus includes a determination unit configured to determine whether the object is a moving object, and a control unit configured to move, during a magnification variation, a focus element to a first target position when the object is not the moving object, and to a second target position when the object is the moving object.

### BACKGROUND OF THE INVENTION

### Field of the Invention

The present invention relates to a focus control which is performed during a magnification variation (zooming) in an imaging apparatus.

### Description of the Related Art

Zoom tracking is performed as a focus control that automatically moves a focus lens, in order to prevent an image plane from moving and causing a blur or to maintain an in-focus state during zooming that moves a magnification varying lens (referred to as a zoom lens). The zoom tracking prepares cam data for each object distance indicating the focus lens position that provides the in-focus state relative to the zoom lens, as illustrated in FIG. 7 and, as the zoom lens is moved, moves the focus lens along the cam data corresponding to the object distance at that time.

As illustrated in FIG. 7, the cam data for each object distance becomes denser on a wider angle side. In zooming from the wide-angle side to the telephoto side, the in-focus state may not be maintained when incorrect cam data for an object distance which is different from an actual object distance is selected and the focus lens is moved along the incorrect cam data.

Japanese Patent No. 3507086 discloses an imaging apparatus that acquires an AF evaluation value which indicates a contrast, from an image signal obtained during zooming, and selects the cam data of a high in-focus degree using the AF evaluation value.

Japanese Patent Laid-Open No. 2017-037103 discloses an imaging apparatus that maintains the in-focus state by performing the so-called imaging plane phase difference AF without using cam data during zooming.

However, in imaging the moving object during zooming, the control of the focus lens while the AF evaluation value is detected as disclosed in Japanese Patent No. 3507086 may be delayed for the moving object and may not maintain the in-focus state or in-focus tracking. The imaging plane phase difference AF disclosed in Japanese Patent Laid-Open No. 2017-037103 cannot perform the in-focus tracking, if the object moves greatly while the focus lens position is being controlled based on a defocus amount which is calculated by using an output signal from the image sensor.

### SUMMARY OF THE INVENTION

The present invention provides a focus control apparatus and an imaging apparatus, each of which can improve an in-focus tracking performance for a moving object during zooming.

A focus control apparatus according to one aspect of the present invention configured to control a position of a focus element using focus position control data configured to reduce an image plane movement due to a magnification variation of an imaging optical system includes a focus detection unit configured to detect a focus state of an object, a distance calculation unit configured to calculate an object distance using the focus state and the focus position control data, a first target position calculation unit configured to use the focus state detected at a first time and the focus position control data to calculate a first target position of the focus element at a second time after the first time, a second target position calculation unit configured to use history information of the object distance which is calculated a plurality of times before the first time to calculate a predicted object distance at the second time, and to use the predicted object distance and the focus position control data to calculate a second target position of the focus element at the second time, a determination unit configured to determine whether the object is a moving object, and a control unit configured to move, during the magnification variation, the focus element to the first target position at the second time when the object is not the moving object, and to the second target position at the second time when the object is the moving object. At least one processor or circuit is configured to perform a function of at least one of the units.

An imaging apparatus including the above focus control apparatus, a focus control method corresponding to the above focus control apparatus, and a storage medium storing a computer program that enables a computer in an imaging apparatus to execute a control method corresponding the control unit also constitute another aspect of the present invention.

Further features of the present invention will become apparent from the following description of exemplary embodiments with reference to the attached drawings.

### BRIEF DESCRIPTION OF THE DRAWINGS

FIG. 1 is a block diagram illustrating a configuration of an imaging apparatus according to a first embodiment of the present invention.

FIGS. 2A to 2C are diagrams illustrating a pixel configuration of an image sensor used in the imaging apparatus in the first embodiment.

FIG. 3A to 3D are diagrams illustrating a pair of a phase difference image signals in the first embodiment.

FIGS. 4A and 4B are diagrams illustrating a correlation amount, a correlation variation amount, and an image shift amount of the pair of phase difference image signals.

FIGS. 5A and 5B are diagrams illustrating a method of calculating a matching level of the pair of phase difference image signals.

FIG. 6 is a flowchart illustrating imaging plane phase difference AF processing in the first embodiment.

FIG. 7 is a diagram illustrating cam data in the first embodiment.

FIG. 8 is a flowchart illustrating AF control processing in the first embodiment.

FIG. 9 is a flowchart illustrating target position selection processing during zooming stop in the first embodiment.

FIGS. 10A to 10C are flowcharts illustrating target position selection processing during zooming in the first embodiment.

FIG. 11 is a flowchart illustrating prediction application condition determination processing in the first embodiment.

FIGS. 12A to 12C are diagrams illustrating a focus control during zooming in the first embodiment.

FIGS. 13A and 13B are diagrams illustrating a prediction control during zooming in the first embodiment.

FIG. 14 is a flowchart illustrating target position selection processing in a second embodiment.

FIG. 15 is a flowchart illustrating AF control processing in a third embodiment.

### DESCRIPTION OF THE EMBODIMENTS

Referring now to the accompanying drawings, a detailed description will be given of embodiments according to the present invention.

### FIRST EMBODIMENT

### Overall Configuration

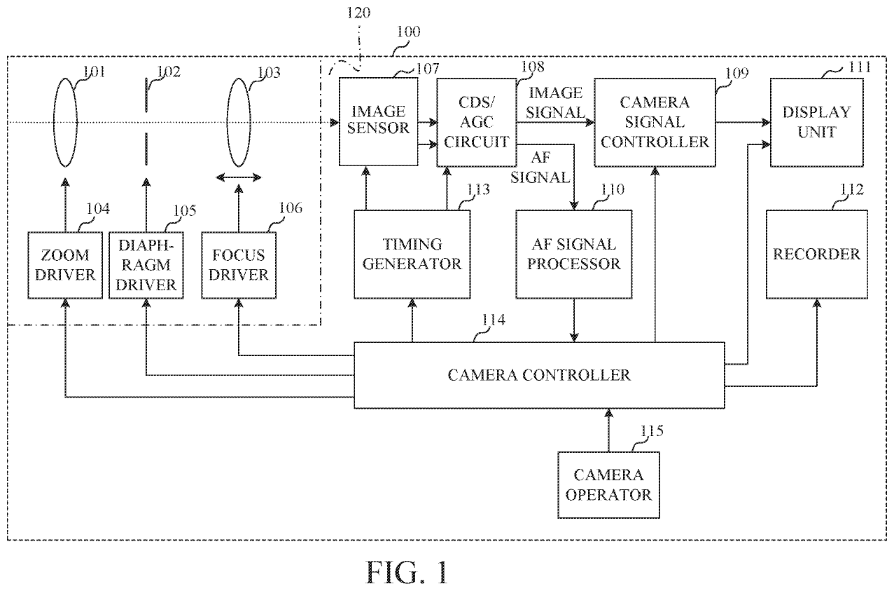

FIG. 1 illustrates a configuration of an imaging apparatus (referred to as a camera hereinafter) 100 having a focus control apparatus according to one embodiment of the present invention. The camera 100 includes a lens unit 120, an image sensor 107, and a camera controller 114. The camera controller 114 serves as a computer in accordance with a control program which is stored in an unillustrated internal ROM or RAM and governs the control of the entire camera 100. For example, it controls a variety of camera operations such as power on/off switching, changing of various settings, an imaging preparation operation including AF, AE and the like, an image recording operation, and recorded image displaying, in response to a user operation input from a camera operator 115.

The lens unit 120 includes an imaging optical system IOS having a zoom lens 101 as a magnification variation element, a diaphragm (aperture stop) 102, and a focus lens 103 as a focus element. The zoom lens 101 is driven by a zoom driver 104 that has received a zoom command from the camera controller 114, and performs the magnification variation (or changes a focal length, referred to as zooming hereinafter). The diaphragm 102 is driven by a diaphragm driver 105 that has received a diaphragm command from the camera controller 114 and controls a light amount. The focus lens 103 is driven by a focus driver 106 that has received a focus command from the camera controller 114 and performs focusing.

The camera controller 114 acquires lens information such as a position of the zoom lens 101 (referred to as a zoom position hereinafter), an aperture diameter (F-number or aperture value) of the diaphragm 102, and the position of the focus lens 103 (referred as focus position hereinafter) from the zoom driver 104, the diaphragm driver 105, and the focus driver 106, respectively. The ROM in the camera controller 114 stores the cam data as focus position control data for a plurality of representative object distances (referred to as representative object distances hereinafter), as illustrated in FIG. 7. The cam data is used for a focus control (zoom tracking) which controls the position of the focus lens 103 in order to reduce the image plane movement which accompanies with the zooming and to maintain the in-focus state. The camera controller 114 performs this focus control. The camera controller 114 serves as a distance calculation unit, a first target position calculation unit, a second target position calculation unit, a determination unit, and a control unit.

The image sensor 107 includes a photoelectric conversion element, such as a CMOS sensor, and photoelectrically converts (captures) the object image formed by a light beam that has passed through the imaging optical system IOS. Charges accumulating in a plurality of pixels of the image sensor 107 are read out as an image signal and an AF signal in accordance with a timing signal output from a timing generator 113 that has received a command from the camera controller 114.

A CDS/AGC circuit 108 performs sampling and a gain control for the image signal and the AF signal which are read out of the image sensor 107. Thereafter, the image signal is output to a camera signal processor 109 and the AF signal is output to an AF signal processor 110.

The camera signal processor 109 generates the image signal by performing various image processing for the image signal output from the CDS/AGC circuit 108. A display unit 111 includes an LCD and the like, and displays a captured image corresponding to the image signal output from the camera signal processor 109. A recorder 112 records the image signal from the camera signal processor 109 in a recording medium such as an optical disc or a semiconductor memory.

The AF signal processor 110 as a focus detection unit performs focus detection processing using the AF signal output from the CDS/AGC circuit 108. As described in detail later, the AF signal is a pair of phase difference image signals (referred to as two image signals hereinafter) that are used for the AF in the imaging plane phase difference detection method (referred to as imaging plane phase difference AF hereinafter). The AF signal processor 110 performs a correlation calculation for the two image signals in order to calculate a phase difference shift amount), and thereafter, calculates a defocus amount which indicates the focus state, from the image shift amount.

The AF signal processor 110 calculates a reliability of the calculated image shift amount or the reliability of the defocus amount (referred to as a focus detection reliability hereinafter). The focus detection reliability will be described in detail later. The AF signal processor 110 outputs the calculated defocus amount and focus detection reliability to the camera controller 114. The camera controller 114 notifies the AF signal processor 110 of a setting change for calculating them according to the acquired defocus amount and focus detection reliability.

### Configuration of Image Sensor 107

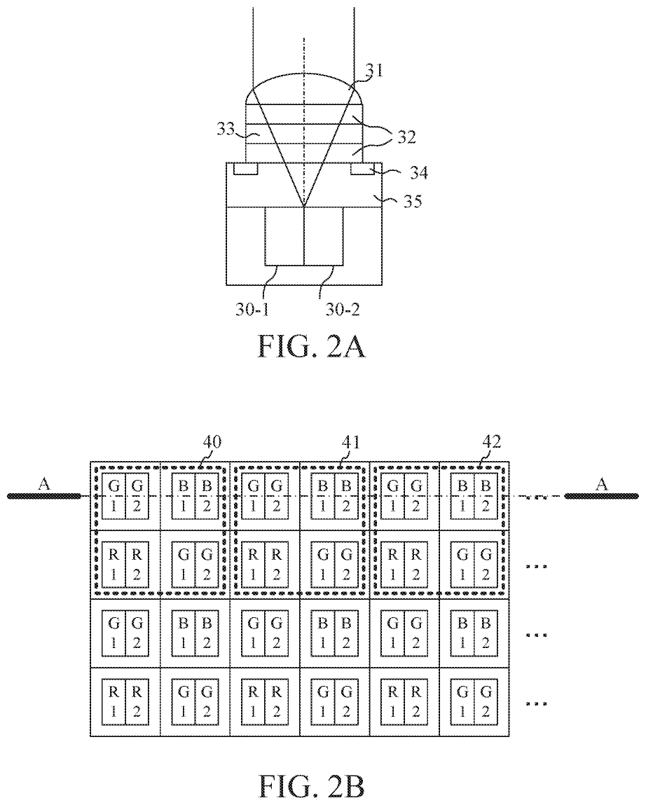

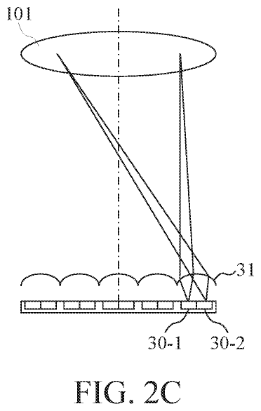

Referring now to FIGS. 2A to 2C, a description will be given of the configuration of the image sensor 107 used for the imaging plane phase difference AF. FIG. 2A illustrates a section of one pixel of the image sensor 107 having a pupil dividing function. One pixel has a single on-chip microlens 31, and a first photoelectric converter 30-1 and a second photoelectric converter 30-2 as two photoelectric converters (subpixels). The pixel is provided with a planarization film 32, a color filter 33, wiring 34, and an interlayer insulation film 35. The number of photoelectric converters provided in one pixel may be larger than two.

FIG. 2B illustrates part of a pixel array in the image sensor 107 viewed from the object side. The entire image sensor 107 has the pixel array illustrated in FIG. 2B, and each pixel has the configuration illustrated in FIG. 2A. All the pixels of the image sensor 107 are divided into four pixels (40, 41, and 42) with 2 horizontal pixels and 2 vertical pixels surrounded by a broken line. R (red), G (green), and B (blue) color filters 33 are provided to each of the four pixels so as to form a Bayer array. In FIG. 2B, “1” and “2” attached below R, G, and B represent the first photoelectric converter 30-1 and the second photoelectric converter 30-2, respectively.

FIG. 2C illustrates a section of the image sensor 107 taken along a line A-A illustrated in FIG. 2B, and the imaging optical system IOS. The image sensor 107 is disposed at a position of an expected imaging plane of the imaging optical system IOS. By an action of the microlens 31, each of the first and second photoelectric converters 30-1 and 30-2 receives one and the other of a pair of the light beams which have passed through different areas (pupil areas) in an exit pupil of the imaging optical system IOS, respectively. More specifically, the first photoelectric converter 30-1 receives the light beam that has passed through the right pupil area in the figure, and the second photoelectric converter 30-2 receives the light beam that has passed through the left pupil area. An “A” image signal of the two image signals is generated by combining the subpixel signals from the first photoelectric converter 30-1 of two or more pixels in a focus detection area 107 that has been set by the user or the camera controller 114 in the image sensor 107. A “B” image signal of the two image signals is generated by combining the subpixel signals from the second photoelectric converter 30-2 of two or more pixels.

A pixel signal from each pixel for generating the image signal is generated by adding two subpixel signals from each pixel. One subpixel signal may be generated by subtracting the other subpixel signal from the pixel signal from each pixel.

### Calculation of Image Shift Amount and Focus Detection Reliability

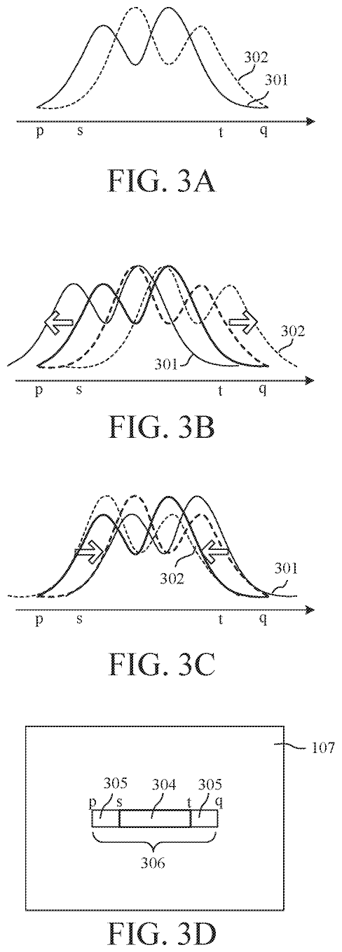

Referring now to FIGS. 3A to 3D, a description will be given of a calculation of the image shift amount performed by the AF signal processor 110. FIG. 3D illustrates a correlation calculation area 306 which includes a focus detection area 304 on the image sensor 107 and shift areas 305 on both sides of the focus detection area 304. FIGS. 3A to 3C illustrates examples of an A image signal 301 and a B image signal 302 both of which are read out of the correlation calculation area 306. The focus detection area 304 is an area used to calculate a correlation amount by the correlation calculation which has been performed on the A image signal 301 and the B image signal 302. The shift areas 305 are the areas necessary for shifting of the A image signal 301 and the B image signal 302 in order to perform the correlation calculation as illustrated in FIG. 3B and 3C. In FIGS. 3A to 3D, p, q, s, and t represent coordinates in an x-axis direction respectively, and p to q represents the correlation calculation area 306. In addition, s to t represents the focus detection area 304.

FIG. 3B illustrates the A and B image signals 301 and 302 shifted in a plus direction before the shifting in FIG. 3A, and FIG. 3C illustrates the A and B image signals 301 and 302 shifted in a minus direction before the shifting in FIG. 3A. In calculating the correlation amount, the AF signal processor 110 shifts the A and B image signals 301 and 302 in the plus or minus direction bit by bit, and calculates a sum of absolute values of a difference of the A and B image signals 301 and 302 after each shift. The AF signal processor 110 calculates a correlation amount COR using the following expression (1) where i is a shift amount, p-s is a minimum shift amount, q-t is a maximum shift amount, and x and y are a start coordinate and an end coordinate of the focus detection area 304 respectively.

$$COR [ i ] = {\sum }_{k = x}^{y} \vert A [ k + i ] - B [ k - i ] \vert \{ ( p - s ) < i < ( q - t ) \} \qquad ( 1 )$$

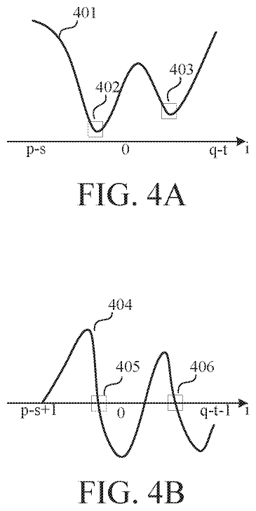

FIG. 4A illustrates an example of a change in a correlation amount (COR) 401 for each shift amount. An abscissa axis represents the shift amount, and an ordinate axis represents the correlation amount. The correlation amount 401 has extreme values 402 and 403. It indicates that as the correlation amount 401 becomes lower, the similarity or the matching level between the A image signal 301 and the B image signal 302 becomes higher.

The AF signal processor 110 calculates a correlation variation amount, for example, from the difference between the shift amounts i−1 and i+1 among the correlation amounts 401 illustrated in FIG. 4A. More specifically, the correlation variation amount ΔCOR is calculated by the following expression (2).

ΔCOR[i]=COR[i−1]−COR[i+1]{(p−s+1)<i<(q−t−1} (2)

FIG. 4B illustrates an illustrative change of the correlation variation amount 404 for each shift amount (ΔCOR). The abscissa axis represents the shift amount, and the ordinate axis represents the correlation variation amount. The correlation variation amount 404 has zero cross points 405 and 406 in which values of the correlation variation amount change from plus to zero and becomes minus. When the correlation variation amount is 0, the matching level is the highest between the A and B image signals. The shift amount when the correlation variation amount becomes 0 is the image shift amount.

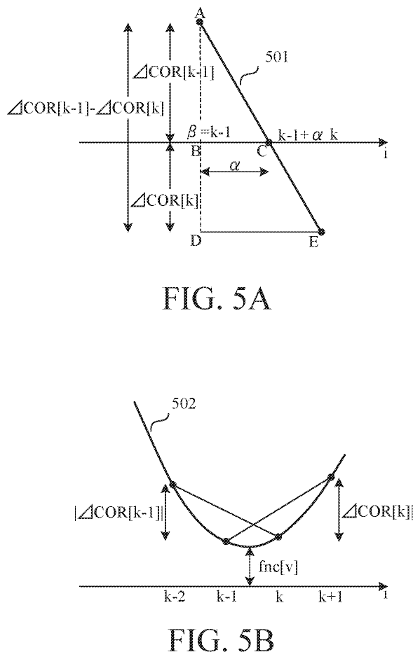

FIG. 5A is an enlarged view of the correlation variation amount 501 near the zero cross point 405 in FIG. 4B. The AF signal processor 110 calculates the image shift amount PRD by dividing it into an integer part β and a decimal part α. The AF signal processor 110 calculates the decimal part α from the similar relationship between a triangle ABC and a triangle ADE which are illustrated in the figure by the following expression (3)

AB:AD=BC:DE

ΔCOR[k−1]:ΔCOR[k−1]−ΔCOR[k]=α:k−(k−1)

$$α = \frac{Δ COR [ k - 1 ]}{Δ COR [ k - 1 ] - Δ COR [ k ]} \qquad ( 3 )$$

In addition, the AF signal processor 110 calculates the integer part β by the following expression (4) as illustrated in FIG. 5A.

β=k−1 (4)

The AF signal processor 110 calculates the image shift amount PRD from the sum of α and β.

When a plurality of zero cross points 405 and 406 exist as illustrated in FIG. 4B, the AF signal processor 110 sets, to the first zero cross point, the zero cross point having the largest steepness maxder of the variation in the correlation variation amount at each zero cross point. The steepness maxder having a larger value represents the easier AF. The AF signal processor 110 calculates the steepness maxder by the following expression (5).

maxder=|ΔCOR[k−1]|+|ΔCOR[k]| (5)

The AF signal processor 110 sets a shift amount that provides the first zero cross point, to an image shift amount PRD.

Further, the AF signal processor 110 calculates the focus detection reliability as follows. A calculation method of the focus detection reliability described below is merely illustrative, and the focus detection reliability may be calculated by another method. In this embodiment, the AF signal processor 110 defines it as the above steepness maxder of the variation in correlation variation amount and the matching level fnclvl between the A image signal and the B image signal (referred to as two-image matching level hereinafter). The two-image matching level indicates that as the value of the two-image matching level becomes higher, an accuracy of the image shift amount or the defocus amount becomes larger. FIG. 5B is an enlarged view of the correlation amount 502 near the extreme value 402 in FIG. 4A. The AF signal processor 110 calculates the two-image matching level using the value of the steepness maxder by following expressions (6).

(i) When |ΔCOR[k−1]|×2≤maxder, fnclvl=COR[k−1]+ΔCOR[k−1]/4

(ii) When |ΔCOR[k−1]|×2>maxder, fnclvl=COR[k]−ΔCOR[k]/4 (6)

### Focus Detection Processing

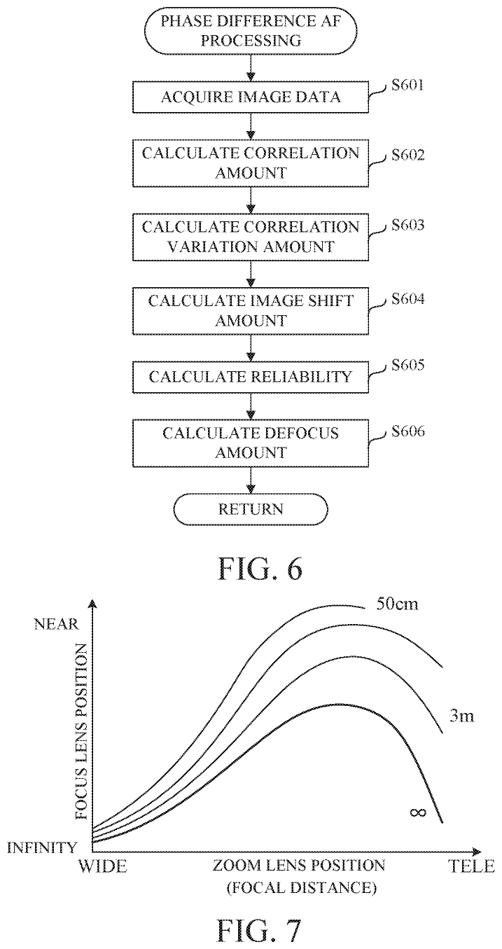

The flowchart in FIG. 6 illustrates a flow of the focus detection processing performed by the AF signal processor 110 in order to calculate the defocus amount. The AF signal processor 110 which is configured by a computer together with the camera controller 114 executes this processing according to a computer program. In the step S601, the AF signal processor 110 acquires the A and B image signals from the pixels in the focus detection area in the image sensor 107.

In the step S602, the AF signal processor 110 calculates the correlation between the acquired A and B image signals and the correlation amount between them. In the step S603, the AF signal processor 110 calculates the correlation variation amount from the calculated correlation amount.

In the step S604, the AF signal processor 110 calculates the image shift amount between the A and B image signals from the correlation variation amount. In the step S605, the AF signal processor 110 calculates the focus detection reliability. Finally, in the step S606, the AF signal processor 110 calculates the defocus amount by multiplying the calculated image shift amount by a predetermined coefficient.

When a plurality of focus detection areas are set, the above focus detection processing is performed for each focus detection area, and the defocus amount is calculated for each focus detection area.

### Focus Detection Reliability

The focus detection reliability calculated by the AF signal processor 110 is an index that indicates the accuracy of the calculated defocus amount, and means that the accuracy becomes higher as the focus detection reliability becomes higher. This embodiment expresses the focus detection reliability by a numerical value from “1” which is the highest to “4” which is the lowest.

The focus detection reliability becomes “1” where the A and B image signals have high contrasts and the two-image matching level is high, or where the object to be imaged is clearly focused. The focus detection reliability becomes “2” where the A and B image signals have high contrasts and the two-image matching level is lower than that of the focus detection reliability of “1” but high to some extent, or where the object is considered to be focused or in a predetermined allowable range. When the focus detection reliability is “1” or “2”, the AF signal processor 110 determines the target position of the focus lens 103 (referred to as a target focus position hereinafter) based on the defocus amount calculated from the image shift amount between the A and B image signals.

The focus detection reliability becomes “3” where the two-image matching level is lower than that of the focus detection reliability of “2”, but a defocus direction is reliable since there is a certain tendency in the correlation amount obtained by shifting the A and B image signals bit by bit. For example, assume that the object is in a state that slightly shifts from the in-focus state. The focus detection reliability becomes “4” where both the contrasts of the A and B image signals and the two-image matching level are lower than those of the focus detection reliability of “3” and neither the defocus amount nor the defocus direction is reliable. For example, assume that the object is so out-of-focus that it is difficult to calculate the defocus amount. When the focus detection reliability is “3” or “4”, the AF signal processor 110 determines the target focus position without depending on the defocus amount calculated from the image shift amount between the A and B image signals.

### AF Control Processing

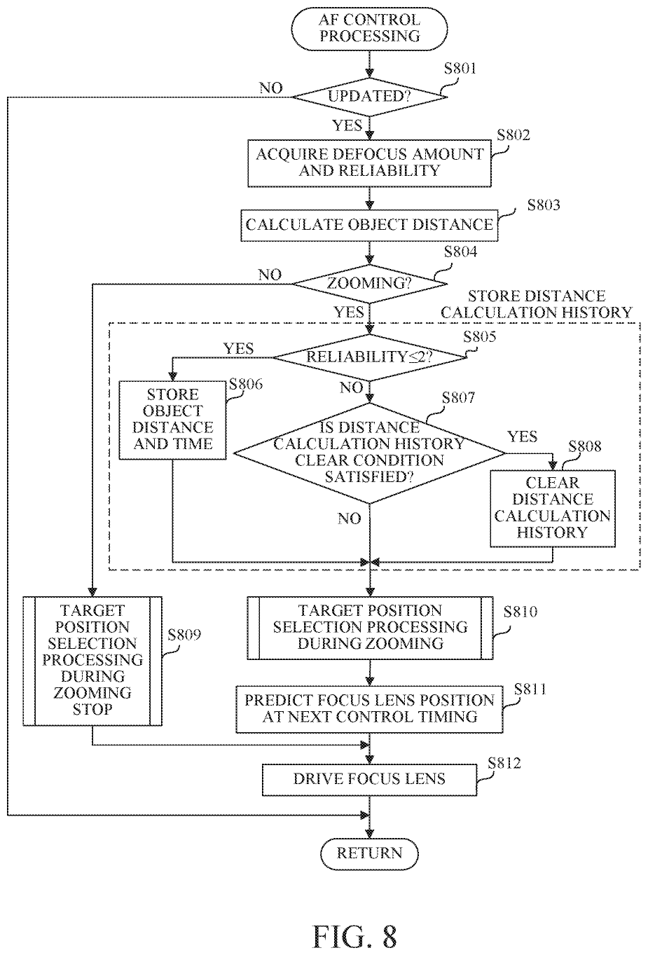

A flowchart in FIG. 8 illustrates a flow of AF control processing performed by the camera controller 114. The camera controller 114 executes the AF control processing according to a computer program stored on the internal ROM. For example, the camera controller 114 executes the AF control processing by setting to a control timing each vertical synchronization timing as a read timing of the image signal from the image sensor 107, which is used to generate one field image (referred to as a single frame or image or screen hereinafter). This processing may be executed for each of a plurality of vertical synchronization timings.

In the step S801, the camera controller 114 checks whether the A and B image signals, which are AF signals, have been updated. If the signals are updated, the camera controller 114 proceeds to the step S802. If the signals are not updated, the camera controller 114 terminates this processing.

In the step S802, the camera controller 114 makes the AF signal processor 110 calculate the defocus amount and the focus detection reliability from the image shift amount between the updated A and B image signals, and acquires the calculated (detected) defocus amount (referred to as a detected defocus amount hereinafter) and focus detection reliability.

In the step S803, the camera controller 114 calculates an in-focus position as a focus position at which the in-focus state is obtained, using the detected defocus amount which has been acquired in the step S802 and the focus position at the update time of the AF signal. Then, the camera controller 114 calculates an object distance corresponding to the in-focus position by using the calculated in-focus position, the zoom position (focal length) when the AF signal is updated, and the cam data. The camera controller 114 generates cam data for the object distance that is not stored on the ROM, through an interpolation using the cam data for two representative object distances adjacent to the object distance which is not stored in the ROM.

In the step S804, the camera controller 114 determines whether zooming is in progress. More specifically, the camera operator 115 determines whether the zoom lens 101 is being driven via the zoom driver 104 in response to the zoom lever in the camera operator 115 being operated by the user. If the zooming is not being performed, the camera controller 114 proceeds to the step S809. If the zooming is being performed, the camera control unit proceeds to the step S805.

In the step S809, the camera controller 114 performs target position selection processing during zooming stop in order to select a target focus position at the current control timing during the zooming stop, and then proceeds to the step S812. The details of the target position selection processing during zooming stop will be described later.

In the step S805, the camera controller 114 determines whether the focus detection reliability acquired in the step S802 is “2” or lower, proceeds to the step S806 in case of the high reliability of “2” or lower, and proceeds to the step S807 in case of the low reliability of “3” or higher.

In the step S806, the camera controller 114 stores the object distance calculated in the step S803 and the time when the AF signal used for the object distance calculation is acquired (updated) (referred to as AF update time hereinafter). The camera controller 114 makes the RAM in the camera controller 114 store plural pieces (five in this embodiment) of information on the object distance and the AF update time as past (before a first time) distance calculation history information which is used in prediction processing described later. When the sixth distance calculation history information is obtained, the camera controller 114 deletes the calculation history information at the oldest AF update time and store the sixth distance calculation history information as the fifth distance calculation history information in the RAM. Thereafter, the camera controller 114 proceeds to the step S810.

Meanwhile in the step S807, the camera controller 114 determines whether a condition for clearing the past distance calculation history information stored in the RAM in the step S806 is met (referred to as a history clear condition hereinafter). In this embodiment, the history clear condition is that a low focus detection reliability of “3” or higher is calculated three times in succession. This is to assume a situation in which a continuity of a calculation result of the object distance is not maintained, such as when an imaging scene switches or a large change (movement) occurs in the object, and to prevent the low reliable distance calculation history information from being used for the moving object determination and the prediction processing which will be described later. While this embodiment describes the configuration of a determination based on the change in the focus detection reliability, the present invention is not limited to this embodiment and may include, for example, means for detecting switching of the imaging scene and the large change in the object.

If the history clear condition is met, the camera controller 114 proceeds to the step S808, clears the past distance calculation history information stored in the RAM, and then proceeds to the step S810. If the history clear condition is not met, it proceeds to the step S810 as it is.

In the step S810, the camera controller 114 performs the target position selection processing during zooming in order to select (set) the target focus position at the current control timing during zooming. The details of the target position selection processing during zooming will be described later. Thereafter, the camera controller 114 proceeds to the step S811.

In the step S811, the camera controller 114 uses the target focus position at the current control timing (first time) selected in the step S810 to calculate the target focus position (first or second target position) at a next control timing second time). The camera controller 114 drives the focus lens 103 along the cam data for a specific object distance according to the change of the zoom position in order to maintain an in-focus state for the specific object distance. Thus, in the step S811, the camera controller 114 calculates the target focus position at the next control timing using the cam data which is stored in the ROM or generated by the interpolation, in order to maintain the in-focus state that has been obtained at the target focus position at the current control timing selected in the step S810. As described above, in order to execute the AF control processing at each control timing as a vertical synchronization timing, the camera controller 114 calculates the target focus position at the next control timing for the focus lens 103 which moves between the current and next control timings or during a control cycle (vertical synchronization period). Thereafter, the camera controller 114 proceeds to the step S812.

In the step S812, the camera controller 114 moves the focus lens 103 to the calculated target focus position via the focus driver 106.

### Target Position Selection Processing During Zooming Stop

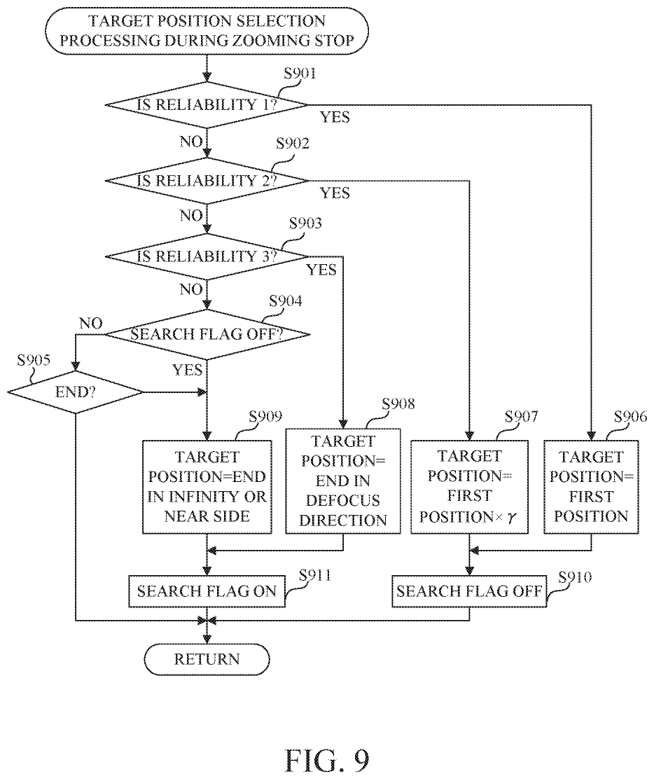

A flowchart in FIG. 9 illustrates a flow of the target position selection processing during zooming stop performed by the camera controller 114 in the step S809 in FIG. 8. In the step S901, the camera controller 114 determines whether the focus detection reliability which has been acquired in the step S802 in FIG. 8 is “1”, proceeds to the step S906 if the focus detection reliability is “1”, and proceeds to the step S902 if the focus detection reliability is not “1”.

As described above, the focus detection reliability of “1” provides the high accuracy of the detected defocus amount obtained in the step S802 and the in-focus state by moving the focus lens 103 to the target focus position calculated from the detected defocus amount. Thus, in the step S906, the camera controller 114 sets, to the target focus position, a first focus position separated from the detected current (first time) focus position (referred to as a current focus position hereinafter) by a moving amount corresponding to the detected defocus amount. In the following description, driving the focus lens 103 to the target focus position based on the detected defocus amount in this way will be referred to as target driving of the focus lens 103.

The camera controller 114 proceeds to the step S910 from the step S906, sets a search flag to OFF, and terminates this processing. The search flag (turned) ON means the search driving for specifying the in-focus position is being performed by moving the focus lens 103 from one end (infinity or close end) of a movable area to the other end. The search flag (turned) OFF means that the search driving is not executed.

If the focus detection reliability is not “1” in the step S901, the camera controller 114 determines whether the focus detection reliability is “2” in the step S902. If the focus detection reliability is “2”, the camera controller 114 proceeds to the step S907, and if the focus detection reliability is not “2”, the camera controller 114 proceeds to the step S903. As described above, when the focus detection reliability is “2”, the detected defocus amount has high accuracy but includes a certain error. Thus, in the step S907, the camera controller 114 calculates a second focus position by multiplying, by a coefficient γ, the first focus position which is obtained by using the current focus position and the detected defocus amount, similar to the step S906, and set the second focus position as the target focus position.

The coefficient γ is a numerical value less than 1, for example 0.8. That is, the camera controller 114 sets the second focus position which is 80% of the first focus position, to the target focus position. In the following description, driving the focus lens 103 to the second focus position closer than the first focus position will be referred to as defocus driving of the focus lens 103. The camera controller 114 proceeds from the step S907 to the step S910, sets the search flag to OFF, and terminates this processing.

In the step S902, if the focus detection reliability is not “2”, the camera controller 114 determines whether the focus detection reliability is “3” in the step S903. If the focus detection reliability is “3”, the camera controller 114 proceeds to the step S908, and if the focus detection reliability is not “3”, the camera controller 114 proceeds to the step S909. As described above, when the focus detection reliability is “3”, the accuracy of the detected defocus amount is low, but the defocus direction indicated by the detected defocus amount (hereinafter referred to as a detected defocus direction) is reliable. Thus, in the step 908, the camera controller 114 performs the search driving by setting the end of the detected defocus direction as the target focus position. The camera controller 114 proceeds to the step S911 from the step S908, sets the search flag to ON, and terminates this processing.

In the step S904, the camera controller 114 determines whether or not the search flag is (turned) OFF. If the search flag is OFF, the camera controller 114 proceeds to the step S909, and if the search flag is (turned) ON, the camera controller 114 proceeds to the step S905.

The process proceeds to the step S909 when the focus detection reliability is “4”, that is, neither the detected defocus amount nor the detected defocus direction is reliable. Therefore, the camera controller 114 sets, to the target focus position, a farther one of the infinity end and the close end from the current focus position in a movable area of the focus lens 103 (namely, the side where the movable range of the focus lens 103 becomes wider), and performs the search driving. The camera controller 114 proceeds to the step S911 from the step S909, sets the search flag to ON, and terminates this processing.

In the step S905, the camera controller 114 determines whether the focus lens 103 has reached the infinity or close end. If the focus lens 103 has reached the infinity or close end, the camera controller 114 proceeds to the step S909. As described above, in the step S909, the camera controller 114 sets an end on a wider side of the movable range to the target focus position. Hence, if the focus lens 103 has reached the infinity or close end, the camera controller 114 sets the other to the target focus position.

In contrast, if the focus lens 103 has reached neither the infinity end nor the close end in the step S905, the camera controller 114 terminates this processing as it is and continues the search driving.

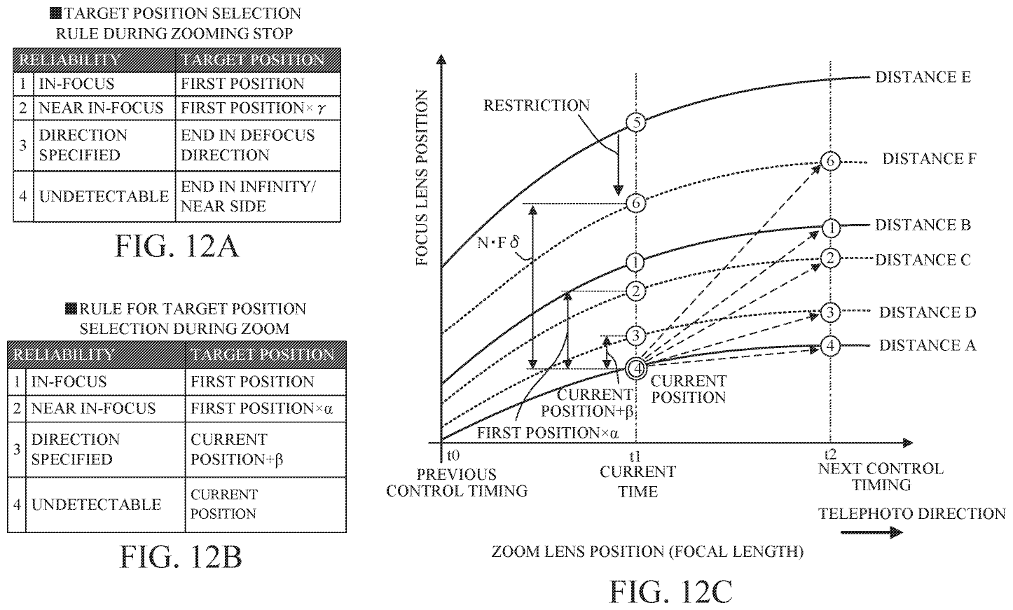

In the target position selection processing during the zooming stop, when the focus detection reliability is high (“1” or “2”), the camera controller 114 sets the target focus position using the detected defocus amount as illustrated in FIG. 12A. When the focus detection reliability is low (“3” or “4”), the camera controller 114 sets the target focus position to the end of the movable area of the focus lens 103 without using the detected defocus amount. Thus, in the AF, as the focus detection reliability is lower, the in-focus position is specified with a larger focus variation.

### Target Position Selection Processing During Zooming

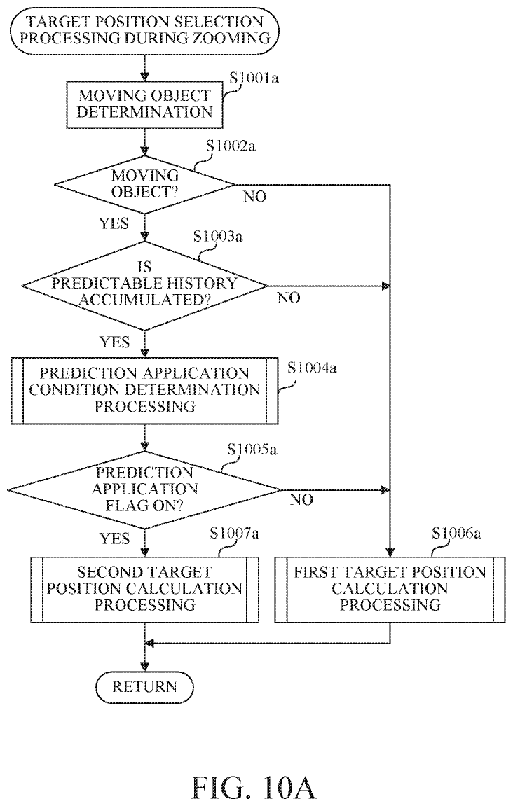

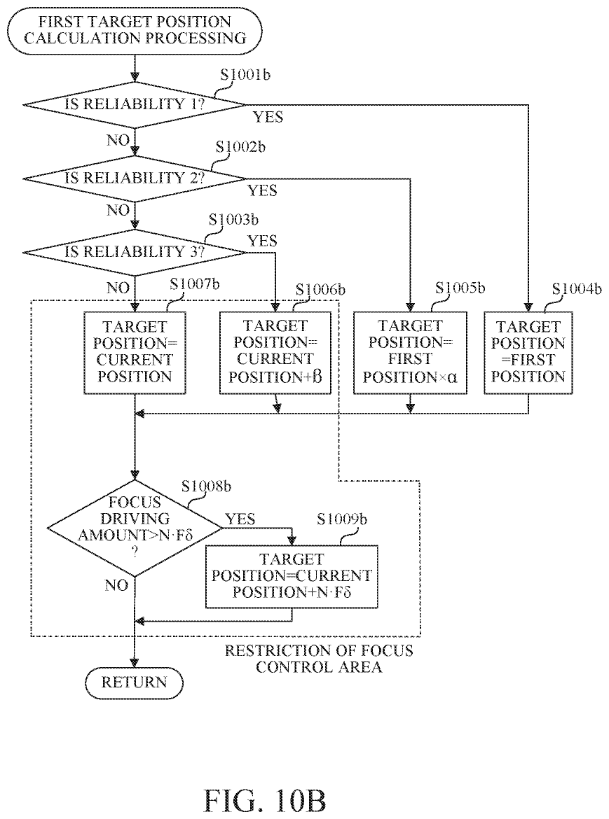

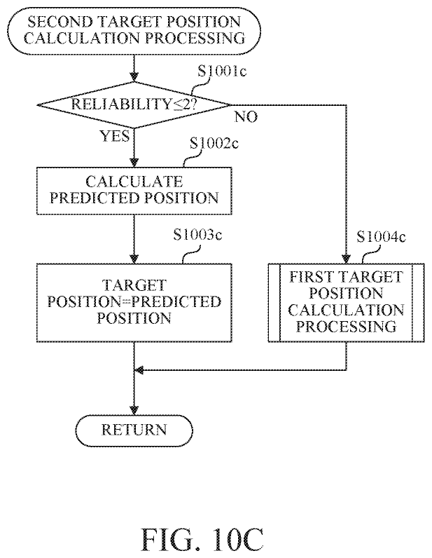

A flowchart in FIG. 10A illustrates a flow of the target position selection processing during zooming performed by the camera controller 114 in the step S810 in FIG. 8. In the step S1001a, the camera controller 114 performs the moving object determination for the object. More specifically, the camera controller 114 determines whether the object is a moving object that moves in the depth direction based on a change in the object distance which has been calculated a plurality of times and stored as the distance calculation history information in the step S806 in FIG. 8.

In the step S1002a, if the result of the moving object determination in the step S1001a indicates that the object is not the moving object, the camera controller 114 proceeds to the step S1006a, and performs first target position calculation processing described in detail later. If the result of the moving object determination indicates that the object is the moving object, the camera controller 114 proceeds to the step S1003a.

In the step S1003a, the camera controller 114 determines whether a predetermined number of pieces of distance calculation history information has been stored in the step S806 in FIG. 8, necessary for the prediction processing described later. If the predetermined history number has been accumulated, the camera controller 114 proceeds to the step S1004a, and if the predetermined history number has not vet been accumulated, the camera controller 114 proceeds to the step S1006a.

In the step S1004a, the camera controller 114 performs prediction application condition determination processing in order to determine whether to perform prediction processing when calculating the target focus position. The details of the prediction application condition determination processing will be described later, but whether to perform the prediction processing is indicated by ON and OFF of a prediction application flag.

In the step S1005a, the camera controller 114 determines whether the prediction application flag is (turned) ON in the step S1004a. If the prediction application flag is ON, the camera controller proceeds to the step S1007a, and performs second target position calculation processing using the result of the prediction processing. If the prediction application flag is OFF, the camera controller 114 proceeds to the step S1006a.

In the target position selection processing during the zooming, if the object is a moving object and the prediction processing is available, the camera controller 114 performs the second target position calculation processing using the result of the prediction processing, and if not, performs the first target position calculation processing without performing the prediction processing. Namely, the camera controller 114 switches the calculation method of the target focus position depending on whether the prediction processing is available.

### First Target Position Calculation Processing

A flowchart in FIG. 10B illustrates a flow of the first target position calculation processing described above. The first target position corresponds to the target focus position at the next control timing that is calculated in the step S811 in FIG. 8 using the target focus position at the current control timing calculated in the steps S1004b, S1005b, S1006b, and S1007b described later.

In the step S1001b, the camera controller 114 determines whether the focus detection reliability acquired in the step S802 in FIG. 8 is “1”, proceeds to the step S1004b if the focus detection reliability is “1”, and proceeds to the step S1002b if the focus detection reliability is not “1”.

In the step S1004b, the camera controller 114 sets, to the target focus position, the first focus position separated from the detected current focus position by the moving amount corresponding to the detected defocus amount, as in the step S906 in FIG. 9. Thereafter, the camera controller 114 proceeds to the step S1008b.

On the other hand, in the step S1002b, the camera controller 114 determines whether the focus detection reliability is “2”, proceeds to the step S1005b if the focus detection reliability is “2”, and proceeds to the step S1003b if it is not “2”.

In the step S1005b, the camera controller 114 calculates the second focus position by multiplying, by a coefficient α, the first focus position obtained using the current focus position and the detected defocus amount, as in the step S1004b, and sets the second focus position to the target focus position. The coefficient α is a numerical value less than 1, for example 0.8. That is, the camera controller 114 sets the second focus position that is 80% of the first focus position, to the target focus position. Thereafter, the camera controller 114 proceeds to the step S1008b.

In the step S1003b, the camera controller 114 determines whether the focus detection reliability is “3”, proceeds to the step S1006b if the focus detection reliability is “3”, and proceeds to the step S1007b if the focus detection reliability is not “3”. Subsequently, the camera controller 114 proceeds to the step S1008b.

In the step S1006b, the camera controller 114 sets, to the target focus position, a focus position separated from the current focus position by a shift amount β in the reliable defocus direction. β is set to about 1Fδ based on a depth of focus Fδ (F is an F-number and δ is a diameter of the permissive circle of confusion). Thereafter, the camera controller 114 proceeds to the step S1008b.

In the step S1007b, since the focus detection reliability is “4”, the camera controller 114 sets the current focus position to the target focus position. The camera controller 114 then proceeds to the step S1008b.

In the step S1008b, the camera controller 114 calculates a driving amount of the focus lens 103 (referred to as a focus driving amount hereinafter), which is the difference between the target focus position set in the steps S1003b to S1007b, and the current focus position, and determines whether the focus driving amount is larger than N·Fδ. For example, N is 5. If the focus driving amount is larger than N·Fδ, the camera controller 114 proceeds to the step S1009b, and if the focus driving amount is equal to or less than N·Fδ, terminates this processing.

In the step S1009b, the camera controller 114 changes the target focus position to the current focus position +N·Fδ so that the focus driving amount does not exceed N·Fδ. In other words, if the focus fluctuation would become large due to the focus driving amount larger than N·Fδ, the camera controller 114 corrects the target focus position so as to prevent the large focus fluctuation regardless of the focus detection reliability.

Thus, in the first target position calculation processing, when the focus detection reliability is high (“1” or “2”) as illustrated in FIG. 12B, the camera controller 114 sets the target focus position using the current focus position and the detected defocus amount. When the focus detection reliability is low (“3” or “4”), the camera controller 114 sets the target focus position to the position separated from the current focus position by the predetermined amount (β or N·Fδ) without using the detected defocus amount.

FIG. 12C indicates the position of the focus lens 103 at certain time t1 (first time) that is the current control timing when the target focus position is selected by the first target position calculation processing and the AF control processing (FIG. 8) is executed, and the position of the focus lens 103 at certain time t2 (second time) that is the next control timing. A to F represent object distances, and have a relationship of A>D>C>B>F>E.

The position represented by a double circle 4 at the time t1 is the current focus position, which is the focus position corresponding to the object distance A. Circles 1 to 3 and the double circle 4 at the time t1 indicate the target focus positions for the focus detection reliabilities “1” to “4” in FIG. 12B, respectively. When the focus detection reliability is “1”, the target focus position is the focus position corresponding to the object distance B, and when the focus detection reliability is “2”, the target focus position is the focus position corresponding to the object distance C. When the focus detection reliability is “3”, the target focus position is the focus position corresponding to the object distance D, and when the focus detection reliability is “4”, as described above, the target focus position is the focus position corresponding to the object distance A. As described in the step S1008b in FIG. 10B, when the focus driving amount is larger than N·Fδ, the target focus position is corrected to the focus position corresponding to the object distance F from the focus position corresponding to the object distance E which is represented by circle 5 at the time t1 in the step S1009b.

The camera controller 114 selects (sets) the target focus position at the time t1 according to the focus detection reliability by the first target position calculation processing. In the step S811 in FIG. 8, the camera controller 114 calculates the target focus position (first target position: represented by the circles 1 to 4 and 6) at the time t2 based on the target focus position at the time t1 and the cam data. In the step S812, the camera controller 114 drives the focus lens 103 toward the target focus position (second target position) at the time t2.

The in-focus state can be maintained during zooming by setting the target focus position depending on the focus detection reliability in the first target position calculation processing.

### Second Target Position Calculation Processing

A flowchart in FIG. 10C illustrates a flow of the second target position calculation processing described above. The second target position corresponds to the target focus position at the next control timing that is calculated in the step S811 in FIG. 8 based on the target focus position at the current control timing calculated in the step S1003c, described later.

In the step S1001c, the camera controller 114 determines whether the focus detection reliability acquired in the step S802 of FIG. 8 is “2” or lower, proceeds to the step S1002c if the focus detection reliability is high or “2” or lower, and proceeds to the step S1004c if the focus detection reliability is low or higher than “2”.

In the step S1004c, the camera controller 114 performs the first target position calculation processing illustrated in FIG. 10B.

Meanwhile, in the step S1002c, the camera controller 114 performs the prediction processing and calculates a predicted focus position at the next control timing (time t2). More specifically, the camera controller 114 calculates the predicted object distance that is an object distance at which the object is predicted to be located at the next control timing, using the distance calculation history information stored in the step S806 in FIG. 8. In the next step S1003c, the camera controller 114 sets, to the target focus position, the predicted focus position which is the focus position corresponding to the predicted object distance. The target focus position set herein is used in the step S811 in FIG. 8.

Thus, in the second target position calculation processing, when the focus detection reliability is high, the target focus position is calculated using the prediction processing. When the focus detection reliability is low, the camera controller 114 proceeds to the first target position calculation processing described above.

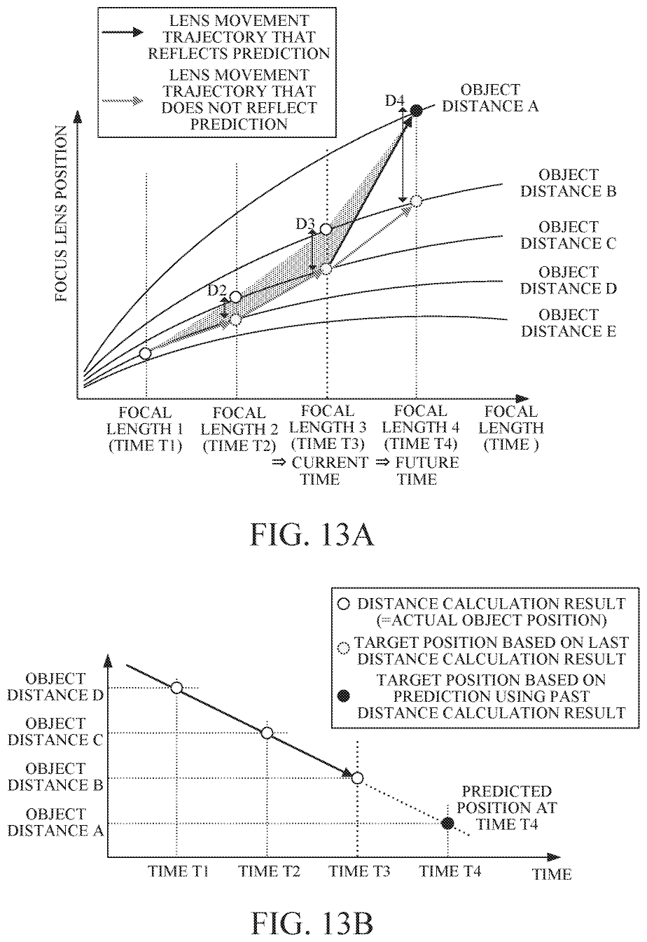

Referring now to FIGS. 134 and 13B, a description will be given of the movement of the focus lens 103 when the second target position calculation processing is performed during zooming. FIG. 13A illustrates the movement trajectory of the focus lens 103. At times T1 to T3, the movement trajectory when the target focus position is updated by the first target position calculation processing is represented. At times T3 to T4, the movement trajectory when the target focus position is updated by the second position calculation processing is represented. FIG. 13B illustrates the object distance as the distance calculation history information, the AF update time when the object distance is the acquired, and the focal length of the imaging optical system at that time, and illustrates that the object distance changes from D at the time T1 to C at the time T2, B at time T3, and A (>B>C>D) at time T4. The camera controller 114 acquires the object distance at each of the times T1 to T4 and updates the target focus position. More specifically, when acquiring the object distance D at the time T1, the camera controller 114 sets the focus position for the object distance D to the target focus position at the time T2, which is the next control timing. When acquiring the object distance C at the time T2, the camera controller 114 sets the focus position for the object distance C to the target focus position at the time T3, which is the next control timing.

If the object is the moving object, a difference D2 arises between the object distance D and the actual object distance at the time T2. Similarly, a difference D3 arises between the object distance C and the actual object distance at the time T3. As a result, the focusing accuracy decreases during the zooming at the times T1 to T3 as indicated by a hatched area in FIG. 13.

Accordingly, at the time T3 (first time), the camera controller 114 calculates the predicted object distance at the time T4 (second time) which is the next control timing, using the distance calculation history information which is acquired before the time T3 and is illustrated in FIG. 13B. More specifically, the camera controller 114 calculates a moving speed of the object (referred to as an object speed hereinafter) using the object distance calculated a plurality of times in the past, and uses the object speed to calculate the predicted object distance at the next control timing. In the example illustrated in FIG. 13A, the camera controller 114 calculates the predicted object distance at time T4 as A, and sets, to the target focus position at the time T4, the focus position corresponding to the predicted object distance A instead of the focus position corresponding to the object distance B. Thereby, the decrease in the focusing accuracy between the time T3 and the time T4 could be suppressed.

Thus, in the second target position calculation processing, the focusing accuracy for the moving object during zooming could be improved by calculating the target focus position from the predicted object distance that is calculated using the distance calculation history information.

The method for calculating the predicted object distance described above is merely illustrative, and the predicted object distance may be calculated using another calculation method.

### Prediction Application Condition Determination Processing

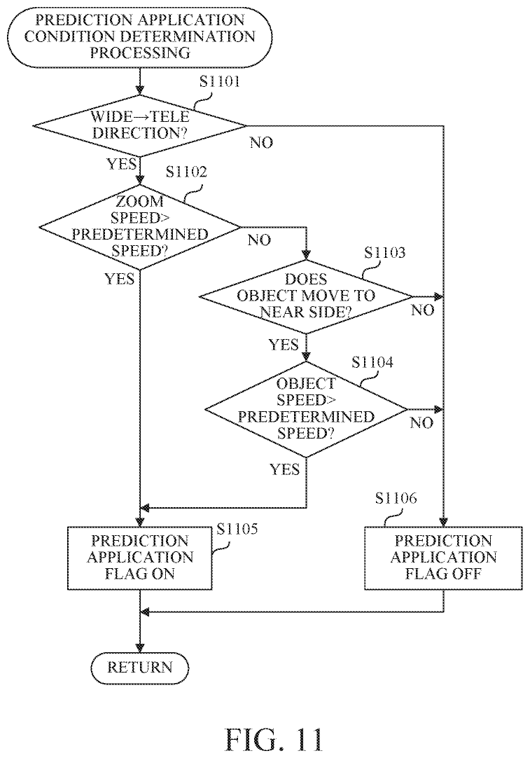

A flowchart in FIG. 11 illustrates a flow of the prediction application condition determination processing that is performed in the step S1004a in FIG. 10A. This prediction application condition determination processing is processing in which the camera controller 114 determines whether to perform the second target position calculation processing, and in which the camera controller 114 selects a condition under which the result of the prediction processing functions effectively.

In the step S1101, the camera controller 114 determines whether a moving direction of the zoom lens 101 (zoom direction) is a telephoto direction or a wide-angle direction. Typically, as the focal length becomes longer (the object is closer to the telephoto end), a depth of field becomes shallower and thus the zooming in the telephoto direction is likely to reduce the focusing accuracy due to the object being the moving object. Accordingly, if the zoom direction is the wide-angle direction in the step S1101, the camera controller 114 proceeds to the step S1106 and turns off the prediction application flag. On the other hand, if the zoom direction is the telephoto direction, the camera controller 114 proceeds to the next step S1102.

In the step S1102, the camera controller 114 determines whether the moving speed of the zoom lens 101 (referred to as a zoom speed hereinafter) is higher than a predetermined speed. When the zoom speed is high, the change in the focal length during the control cycle becomes large. Particularly when the zoom direction is the telephoto direction, the change in the focus position represented by the cam data also becomes large. Thus, the difference between the object distance corresponding to the current focus position at each control timing and the actual object distance is also increased, and the focusing accuracy decreases. If the zoom speed is higher than the predetermined speed in the step S1102, the camera controller 114 proceeds to the step S1105 and turns on the prediction application flag. On the other hand, if the zoom speed is equal to or less than the predetermined speed, the camera controller 114 proceeds to the step S1103.

In the step S1103, the camera controller 114 determines whether the moving direction of the object in the depth direction is a short-distance direction (close side) approaching the camera 100 or an infinity direction (far side) moving away from the camera 100. Typically, the depth of field becomes shallower as the object distance becomes shorter. When the object is the moving object and moves to the close side, the focusing accuracy is likely to lower. The camera controller 114 determines the moving direction of the object, proceeds to the step S1106 if the object moves to the far side, and turns OFF the prediction application flag. On the other hand, if the object moves to the close side, the camera controller 114 proceeds to the step S1104.

In the step S1104, the camera controller 114 determines whether the object speed is higher than the predetermined speed. More specifically, the object speed is calculated using the distance calculation history information stored in the step S806 in FIG. 8. As described in the step S1103, the depth of field becomes shallower as the object distance becomes shorter, and the focusing accuracy is likely to decrease due to the object being the moving object as the object speed is higher and the change in the object distance within the control cycle is larger. Thus, if the object speed is higher than the predetermined speed, the camera controller 114 proceeds to the step S1105, turns on the prediction application flag, and terminates this processing. On the other hand, if the object speed is equal to or lower than the predetermined speed, the camera controller 114 proceeds to the step S1106, turns off the prediction application flag, and terminates this processing.

Thus, in the prediction application condition determination processing, the prediction processing is actively performed under a condition where the prediction processing may improve the focusing accuracy during the zooming, that is, a condition where a focusing error may increase due to the object being the moving object. This configuration can provide a focus control that emphasizes the in-focus tracking performance for a moving object and, a focus control that emphasizes a continuity and stability of the focus fluctuation during the zooming based on the latest distance calculation result under a condition in which the focusing error does not increase.

In the imaging plane phase difference AF during the zooming, the above embodiment sets the target focus position using the calculation method (calculation method including the prediction processing) for the object that is the moving object different from the calculation method for the object that is not the moving object, in selecting the target focus position depending on the defocus amount and the focus detection reliability. Thereby, this embodiment can improve the in-focus tracking performance for the moving object during the zooming.

### SECOND EMBODIMENT

A description will be given of a second embodiment according to the present invention. In this embodiment, whether to perform the prediction processing is selected depending on the difference between the target focus position when the prediction processing is performed and the target focus position when the prediction process is not performed in the target position calculation processing during zooming and the prediction application condition determination processing in the first embodiment. The camera configuration and the processing other than the target position calculation processing during zooming and the prediction application condition determination processing in this embodiment is the same as those of the first embodiment.

### Target Position Calculation Processing During Zooming

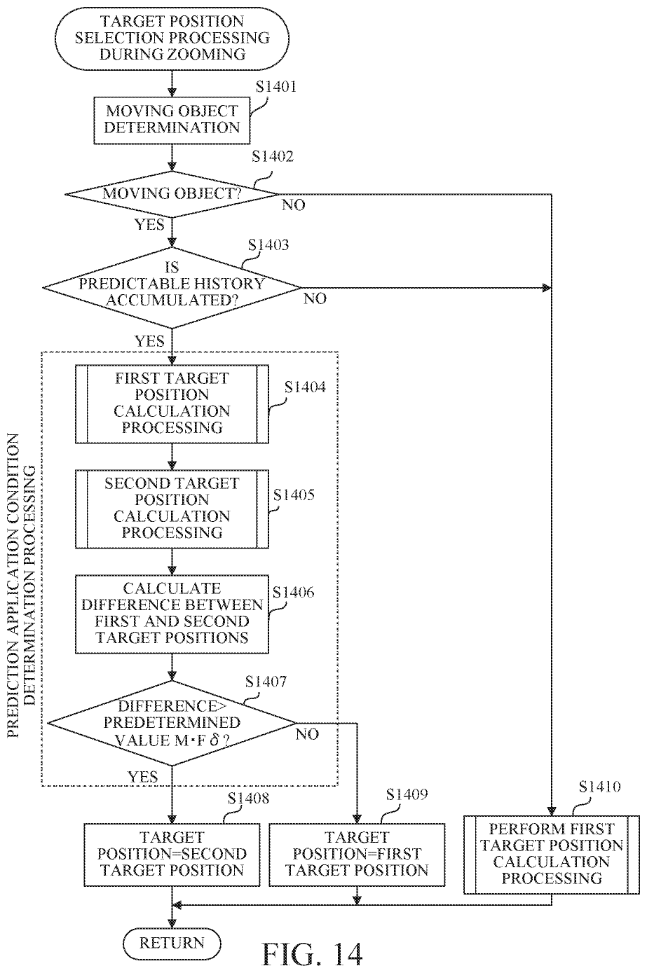

A flowchart of FIG. 14 illustrates a flow of the target position calculation processing during zooming including the prediction application condition determination processing in this embodiment. The processing from the step S1400 to the step S1403 is the same as the processing from the step S1000a to the step S1003a in FIG. 10. If the number of distance calculation histories necessary for the prediction processing is not accumulated in the step S1403, the camera controller 114 performs the first target position calculation processing in the step S1410 similar to the step S1006a in FIG. 10A.

If the number of distance calculation histories necessary for the prediction processing is accumulated in the step S1403, the camera controller 114 proceeds to the step S1404. In the step S1404 and subsequent steps, the camera controller 114 performs the prediction application condition determination processing different from that of the first embodiment.

In the step S1404, the camera controller 114 performs the first target position calculation processing, and calculates the first target focus position at the next control timing using the current distance calculation result.

In the step S1405, the camera controller 114 performs the second target focus position calculation processing, and calculates the second target position corresponding to the predicted object distance at the next control timing using the current distance calculation result and the distance calculation history information.

In the next step S1406, the camera controller 114 calculates the difference between the first target focus position and the second target focus position calculated in the steps S1404 and S1405, respectively. For example, if the time T3 illustrated in FIG. 13A is the current time, the camera controller 114 calculates the first target focus position (represented by a black dot), the second target focus position (represented by a broken-line dot) at the time T4, which is the next control timing, and then a difference D4 between them.

In the step S1407, the camera controller 114 determines whether or not the difference calculated in the step S1406 is larger than a predetermined value M·Fδ. Namely, the camera controller 114 determines whether or not the D4 that is the difference caused by the presence and absence of the prediction processing is larger than M times the focal depth Fδ (for example, M=3). If the difference is larger than the predetermined value in the step S1407, the camera controller 114 proceeds to the step S1408, and if the difference is equal to or smaller than the predetermined value, the camera controller 114 proceeds to the step S1409.

In the step S1408, the camera controller 114 sets, to the target focus position, the second target focus position calculated in the step S1405. On the other hand, in the step S1409, the camera controller 114 sets, to the target focus position, the first target focus position calculated in the step S1404.

If the difference between the first and second target focus positions is less than or equal to a predetermined value, this embodiment can provide the focus control that emphasizes the continuity and stability of the focus fluctuation using the latest distance calculation result. On the other hand, if the difference is larger than the predetermined value or under the condition that the focusing error increases due to the object being the moving object, this embodiment can maintain the focusing accuracy using the second target focus position obtained by performing the prediction processing.

In the imaging plane phase difference AF during the zooming, this embodiment also sets the target focus position using the calculation method (calculation method including the prediction processing) for the object that is the moving object different from the calculation method for the object that is not the moving object, in selecting the target focus position depending on the defocus amount and the focus detection reliability. Thereby, this embodiment can improve the in-focus tracking performance for the moving object during the zooming.

### THIRD EMBODIMENT

A description will now be given of a third embodiment according to the present invention. This embodiment stores the distance calculation history information in the AF control processing regardless of whether zooming is being performed, and uses it for the prediction processing during the zooming. The camera configuration and the processing other than the AF control processing in this embodiment is the same as those of the first embodiment.

### AF Control Processing

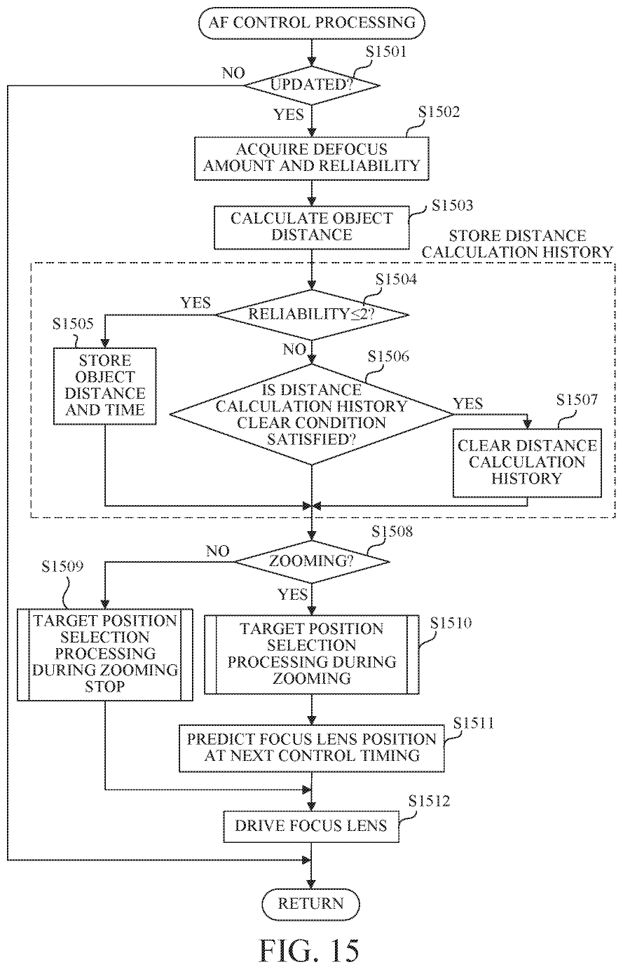

A flowchart of FIG. 15 illustrates a flow of AF control processing in this embodiment. The steps S1501 to S1503 in FIG. 15 are the same as the steps S801 to S803 in FIG. 8. The steps S1504 to S1507 in FIG. 15 are the same as the steps S805 to S808 in FIG. 8. The steps S1508 to S1512 in FIG. 15 are the same as the steps S804 and S809 to S812 in FIG. 8.

The AF control processing in this embodiment is different from the AF control processing illustrated in FIG. 8 in the first embodiment in timing of the processing relating to storing of the distance calculation history information (steps S1504 to S1507) surrounded by the broken line in FIG. 15. More specifically, the control AF processing in FIG. 8 stores the distance calculation history information only during zooming and performs the prediction processing using the distance calculation history information, but in contrast, this embodiment stores the distance calculation history information in the step S1508 prior to the determination of whether the zooming is in progress. Thereby, the camera controller 114 stores the distance calculation history information regardless of whether the zooming is in progress.

This embodiment can store the latest distance calculation result as the history information regardless of whether the zooming is in progress, and perform the prediction processing immediately after the zooming starts.

In the imaging plane phase difference AF during the zooming, this embodiment also sets the target focus position using the calculation method (calculation method including the prediction processing) for the object that is the moving object different from the calculation method for the object that is not the moving object, in selecting the target focus position depending on the defocus amount and the focus detection reliability. Thereby, this embodiment can improve the in-focus tracking performance for the moving object during the zooming.

In each of the above embodiments, the focus lens as the focus element is moved along with the zooming. However, the image sensor may be used as the focus element and moved along with the zooming.

### OTHER EMBODIMENTS

Embodiment(s) of the present invention can also be realized by a computer of a system or apparatus that reads out and executes computer executable instructions (e.g., one or more programs)recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Each embodiment can improve the in-focus tracking performance for a moving object during zooming.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-003749, filed on Jan. 11, 2019), which is hereby incorporated by reference herein in its entirety.

What is claimed is:

1. A focus control apparatus configured to control a position of a focus element using focus position control data configured to reduce an image plane movement due to a magnification variation of an imaging optical system, the focus control apparatus comprising:
a focus detection unit configured to detect a focus state of an object;
a distance calculation unit configured to calculate an object distance using the focus state and the focus position control data;
a first target position calculation unit configured to use the focus state detected at a first time and the focus position control data to calculate a first target position of the focus element at a second time after the first time;
a second target position calculation unit configured to use history information of the object distance which is calculated a plurality of times before the first time to calculate a predicted object distance at the second time, and to use the predicted object distance and the focus position control data to calculate a second target position of the focus element at the second time;
a determination unit configured to determine whether the object is a moving object; and
a control unit configured to move, during the magnification variation, the focus element to the first target position at the second time when the object is not the moving object, and to the second target position at the second time when the object is the moving object,
wherein at least one processor or circuit is configured to perform a function of at least one of the units.

2. The focus control apparatus according to claim 1, wherein when a reliability of the focus state is a high reliability, the first target position calculation unit calculates the first target position using the focus state detected at the first time and the focus position control data, and
wherein when the reliability is lower than the high reliability, the first target position calculation unit calculates the first target position using the position of the focus element detected at the first time and the focus position control data without using the focus state.

3. The focus control apparatus according to claim 1, wherein the control unit moves the focus element to the first or second target position when the object is the moving object and at least a direction of the magnification variation is a telephoto direction.

4. The focus control apparatus according to claim 1, wherein the control unit moves the focus element to the second target position when the object is the moving object and at least a speed of the magnification variation is higher than a predetermined speed.

5. The focus control apparatus according to claim 1, wherein during the magnification variation, the control unit moves the focus element to the second target position when at least the moving object moves to a short-distance direction.

6. The focus control apparatus according to claim wherein during the magnification variation, the control unit moves the focus element to the second target position when at least a speed of the moving object is higher than a predetermined value.

7. The focus control apparatus according to claim 1, wherein during the magnification variation, the control unit moves the focus element to the second target position when the object is the moving object and at least a difference between the first target position and the second target position is larger than a predetermined value.

8. The focus control apparatus according to claim 1, wherein the second target position calculation unit generates the history information regardless of whether the magnification variation is performed.

9. An imaging apparatus comprising
an image sensor configured to image an object; and
a focus control apparatus,
wherein the focus control apparatus is configured to control a position of a focus element using focus position control data configured to reduce an image plane movement due to a magnification variation of an imaging optical system, and includes:
a focus detection unit configured to detect a focus state of an object;
a distance calculation unit configured to calculate an object distance using the focus state and the focus position control data;
a first target position calculation unit configured to use the focus state detected at a first time and the focus position control data to calculate a first target position of the focus element at a second time after the first time;
a second target position calculation unit configured to use history information of the object distance which is calculated a plurality of times before the first time to calculate a predicted object distance at the second time, and to use the predicted object distance and the focus position control data to calculate a second target position of the focus element at the second time;
a determination unit configured to determine whether the object is a moving object; and
a control unit configured to move, during the magnification variation, the focus element to the first target position at the second time when the object is not the moving object, and to the second target position at the second time when the object is the moving object.

10. A focus control method configured to control a position of a focus element using focus position control data configured to reduce an image plane movement due to a magnification variation of an imaging optical system, the focus control method comprising the steps of:
detecting a focus state of an object;
calculating an object distance using the focus state and the focus position control data;
using the focus state detected at a first time and the focus position control data to calculate a first target position of the focus element at a second time after the first time;
using history information of the object distance which is calculated a plurality of times before the first time to calculate a predicted object distance at the second time, and using the predicted object distance and the focus position control data to calculate a second target position of the focus element at the second time;
determining whether the object is a moving object; and
moving, during the magnification variation, the focus element to the first target position at the second time when the object is not the moving object, and to the second target position at the second time when the object is the moving object.

11. A non-transitory computer-readable storage medium storing a computer program that causes a computer in an imaging apparatus to execute the focus control method according to claim 10.
